(19) United States
(12) Patent Application Publication
(10) Pub. No.: US 2008/0047392 A1
(43) Pub. Date: Feb. 28, 2008

(54) Torsional vibration damper hub assembly for an engine

(75) Inventor: Michael P. Ciaccio, Chelsea, MI (US)

Correspondence Address: JOHN S. BEULICK (19121), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/509,190

(22) Filed: Aug. 24, 2006

(51) Int. Cl. F16F 15/12; F02B 75/06

(52) U.S. Cl. 74/574.4; 123/192.1

(57) ABSTRACT

A torsional vibration damper hub assembly for a motor vehicle engine includes, in an exemplary embodiment, a hub formed from a filled thermoplastic material and having an outer wall. The thermoplastic material includes at least one filler. The assembly can also include a metal sleeve molded into the hub where the sleeve is overmolded with the filled thermoplastic material, an inertia ring positioned inside the hub, a rubber insert positioned between the inertia ring and the outer wall of the hub, and an end cap coupled to the hub enclosing the inertia ring the said rubber insert inside the hub.

### BACKGROUND OF THE INVENTION

This invention relates generally to internal combustion engines, and more particularly, to a tortional vibration damper hub assembly formed at least partially from a filled thermoplastic material.

Torsional vibrations are back-and-forth twistings of the crankshaft of an internal combustion engine, superimposed upon the main, uni-directional rotation of the crankshaft. Unless controlled, such torsional vibrations can lead to failure of the crankshaft, as well as contributing to failure in other parts of the engine, particularly where one of the resonant frequency modes of the crankshaft coincides with the particular firing induced, excitation frequency of the engine.

A known form of a tortional damping device includes an outer or inertia member in the form of a ring of some significant mass. The inner portion of this ring is attached to an elastomer annulus which, in turn, is secured to a hub or other element in turn attached to the rotating crankshaft of an engine. As the crankshaft is turning, each incremental application of torque results in a slight acceleration of the metal adjacent the crank arm. When the metal recovers, due to its natural elasticity or resilience, it rotates slightly in the opposite direction. Such forces often result in torsional vibrations in the shaft. The purpose of a torsional vibration damper is to reduce the amplitude of torsional vibrations. Such reduction lowers the strength requirements of the crankshaft and hence lowers the weight of the crankshaft. The damper also prevents breakage of the crankshaft as well as inhibiting vibration of various other components of the internal combustion engine which reduces noise and improves driver comfort.

Prior torsional vibration constructions of the type having a hub, elastomer member, and inertia ring have generally employed materials of relatively high density for both the hub and the inertia member. The relatively high density and accompanying relatively high damping ability of the inertia member on account of its mass is a desirable feature. However, the use of high density material such as cast iron for the hub may result in undesirable effects, for example, paracitic inertia which inhibits quick acceleration and de-acceleration of the crankshaft (reduced fuel efficiency and performance) while adding little or no value to reduced vibration. Thus whenever any rotary mass, such as a torsional vibration damper, is added to the crankshaft of an engine, the resonant frequency of that crankshaft is lowered. Such lowering may bring critical resonant vibration orders of the crankshaft near or within the operating range of speeds of the engine.

Further, because the torsional vibration damper is typically used as a drive pulley for the engine accessory drive belt, polyvee grooves need to be machined into the outer surface of the metal inertia ring. The machining process adds to manufacturing time and as a result adds to component costs.

### BRIEF DESCRIPTION OF THE INVENTION

In one aspect, a torsional vibration damper hub assembly for a motor vehicle engine is provided. The torsional vibration damper hub assembly includes a hub formed from a filled thermoplastic material and having an outer wall. The thermoplastic material includes at least one filler. The assembly can also include a metal sleeve molded into the hub where the sleeve is insert molded with the filled thermoplastic material, an inertia ring positioned inside the hub, a rubber insert positioned between the inertia ring and the outer wall of the hub, and an end cap coupled to the hub enclosing the inertia ring the said rubber insert inside the hub.

In another aspect, a motor vehicle engine is provided. The engine includes an engine block, a crank shaft located in the engine block, at least one accessory attached to the engine block, an accessory drive belt coupled to each accessory, and a torsional vibration damper hub assembly coupled to the crank shaft and to the accessory drive belt. The torsional vibration damper hub assembly includes a hub comprising a filled thermoplastic material and having an outer wall. The thermoplastic material includes at least one filler. The assembly can also include a metal sleeve molded into the hub where the sleeve is insert molded with the filled thermoplastic material, an inertia ring positioned inside the hub, a rubber insert positioned between the inertia ring and the outer wall of the hub, and an end cap coupled to the hub enclosing the inertia ring the said rubber insert inside the hub.

### BRIEF DESCRIPTION OF THE DRAWINGS

FIG. 1 is an illustration of a vehicle engine that includes a tortional vibration hub assembly in accordance with an embodiment of the present invention.

FIG. 2 is a front exploded schematic illustration of the tortional vibration hub assembly shown in FIG. 1.

FIG. 3 is a rear exploded schematic illustration of the tortional vibration hub assembly shown in FIG. 1.

FIG. 4 is a sectional schematic illustration of the tortional vibration hub assembly shown in FIG. 1.

### DETAILED DESCRIPTION OF THE INVENTION

A tortional vibration hub assembly for an internal combustion engine is described below in detail. The tortional vibration hub assembly has an internal mass design and includes a hub member formed from thermoplastic material containing reinforcing fillers, an inertia ring, a rubber insert, an end cap, and in alternate embodiments, a metal sleeve. The tortional vibration hub assembly eliminates the majority of machining required for a traditional cast iron, aluminum or steel torsional vibration dampers thus reducing cost. Also, by utilizing a high strength injection molded polymer material, a unique construction with an end cap to provide added structure and an internal mass construction costs are reduced. Internal mass designs have polyvee grooves as a part of the hub, not the inertia ring. The use of high strength polymer materials also eliminates the need for paint, lowering cost, and reduces parasitic inertia by reducing the weight of the hub. The use of polymer materials over metals also improves NVH characteristics (ringing) of the torsional vibration damper. Internal mass designs have inherently lower stresses on the rubber, allowing for the use of lower cost rubber. Internal mass designs also have an inherent “limp-home” failure mode where the car can still be driven home even if the inertia ring come off because the belt rides on the hub, not the inertia ring.

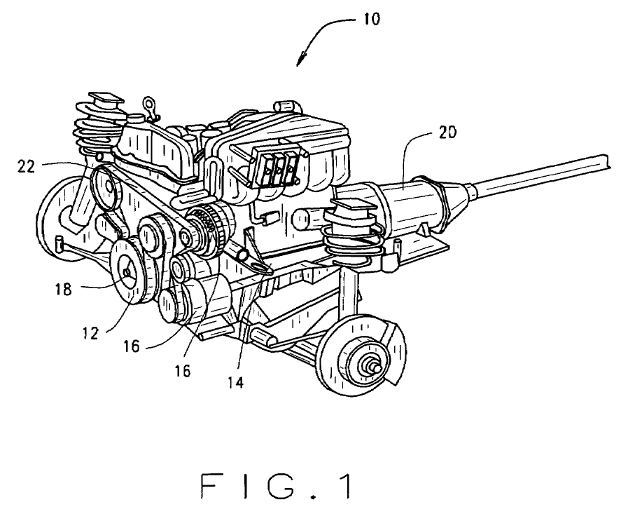

Referring to the drawings, FIG. 1 is an illustration of a vehicle engine 10 that includes a tortional vibration hub assembly 12 in accordance with an embodiment of the present invention. Engine 10 includes an engine block 14 and a plurality of accessories 16, for example, an air conditioning compressor, a power steering pump, an alternator, and the like, attached to engine block 14. A crank shaft 18 extends through engine block 14 and is coupled to a transmission 20 at the rear of engine 10. Tortional vibration hub assembly 12 is attached to crank shaft 18 at the front of engine 10 by, for example, a press fit or bolts. An accessory drive belt 22 is coupled to tortional vibration hub assembly 12 and to each accessory 16. Accessories 16 are driven by accessory drive belt 22 which in turn is driven by tortional vibration hub assembly 12. The rotation of crank shaft 18 causes tortional vibration hub assembly 12 to rotate which drives accessory drive belt 22.

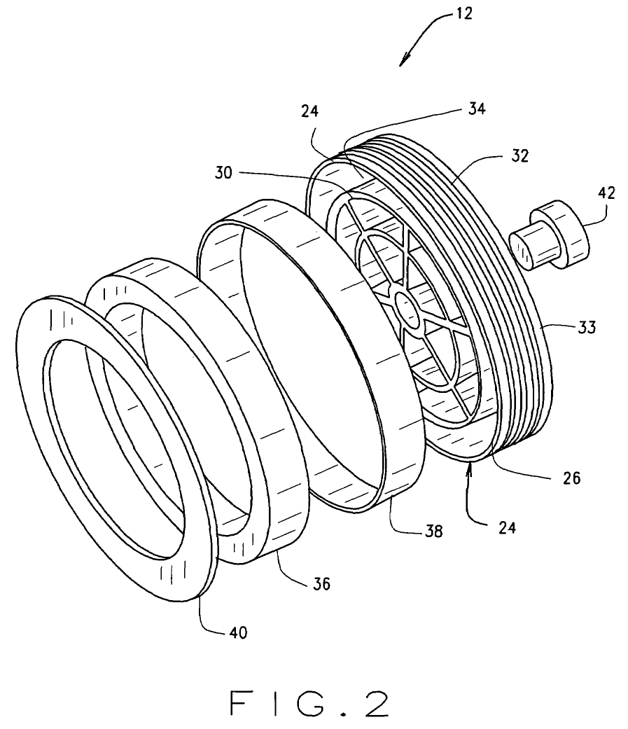

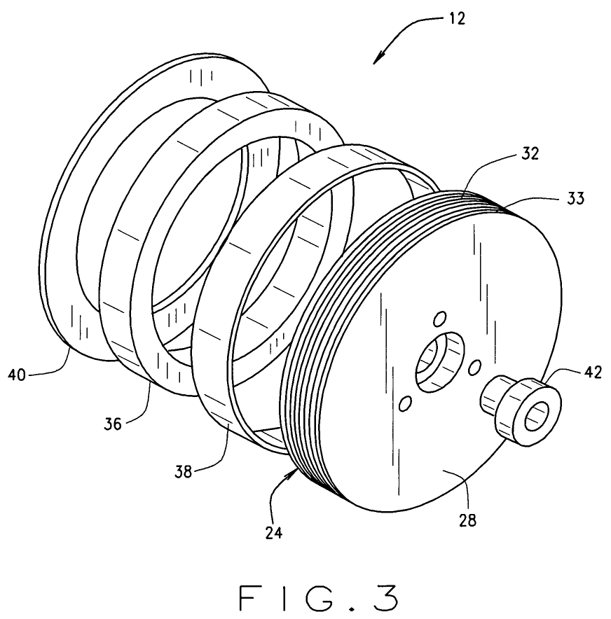

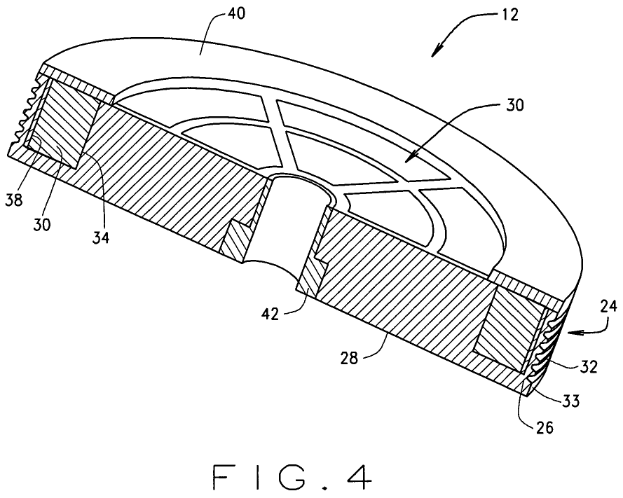

Referring to FIGS. 2-4, tortional vibration hub assembly 12, in an exemplary embodiment, includes a hub member 24 formed from a thermoplastic material that includes reinforcing fillers. In one embodiment, hub member 24 is formed by an injection molding technique. Hub member 24 includes an outer wall 26, a back wall 28, and a center portion 30. A plurality of polyvee grooves 32 are located in an outer surface 33 of outer wall 26. Accessory drive belt 22 (shown in FIG. 1) includes vee grooves (not shown) which mate with polyvee grooves 32. Polyvee grooves 32 in outer wall 26 of hub member 24 keeps accessory drive belt 22 aligned on tortional vibration hub assembly 12 during operation of engine 10. Center portion 30 is coupled to outer wall 26 by back wall 28. Outer wall 26, back wall 28, and center portion 30 define a cavity 34.

An inertia ring 36 and a rubber insert 38 are positioned inside cavity 34 with rubber insert 38 located between inertia ring 36 and outer wall 26. Rubber insert 38, in one embodiment, is in strip form and press fit between outer wall 26 and inertia ring 36. In another embodiment, rubber insert 38 is a molded ring of rubber that is press fit between outer wall 26 and inertia ring 36. In another embodiment, rubber insert 38 is injection molded between outer wall 26 and inertia ring 36. In still another embodiment, rubber insert 38 is molded to hub member 24 or inertia ring 36 in a “dual shot” process. Rubber insert 38 is formed from any suitable rubber materials, for example, ethylene propylene diene monomer rubber (EPDM), styrene butadiene rubber (SBR), natural rubber, polybutadiene, acrylonitrile butadadiene rubber (NBR), and acrylic. Inertia ring 36 is formed from any suitable material, for example, steel, cast iron, or a filled thermoplastic material.

An end cap 40 formed from a thermoplastic material is attached to hub member 24 enclosing inertia ring 36 and rubber insert 38 inside cavity 34. End cap 40 is attached to hub member 24 by any known method, for example, by vibration welding, laser welding, adhesive bonding, spin welding, or other known methods of attachment commonly used between polymer based materials. In alternate embodiments, hub member 24 and end cap 40 include interlocking features to facilitate locating end cap 40 relative to hub member 24, to provide additional surface area for bonding, and/or to provide added strength.

In one embodiment, a metal sleeve 42 is insert molded onto center portion 30. Metal sleeve 42 is sized to receive the front end of crank shaft 18 (shown in FIG. 1) to attach tortional vibration damper hub assembly 12 to crank shaft 18. Metal sleeve 42 provides strength for a press fit over the front end of crank shaft 18 and for removal operations with a wheel puller.

Suitable thermoplastic resins for use in molding hub member 24 end cap 40, and/or inertia ring 36 include, but are not limited to, polyamids, for example semi-crystalline polyamids, such as, nylon 66 and nylon 6 commercially available from General Electric Company, polyphenylene sulfides, polyphthalamides, polyethyl imides, and mixtures thereof. The reinforcing fillers used to reinforce the thermoplastic resin can be in the form of particles and/or fibers. Suitable fillers for use in reinforcing the thermoplastic resins include, but are not limited to metal fibers, metalized inorganic fibers, metalized synthetic fibers, glass fibers, graphite fibers, carbon fibers, ceramic fibers, mineral fibers, basalt fibers, inorganic fibers, aramid fibers, mineral fillers, and mixtures thereof. Suitable, non-limiting, examples of mineral fillers include barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, and mixtures thereof. In one embodiment, the thermoplastic material includes about 20% to about 80% by weight of reinforcing fillers, and in another embodiment from about 30% to about 55% by weight of reinforcing fillers.

Tortional vibration hub assembly 12, described above, eliminates the majority of machining required for known cast iron, aluminum or steel torsional vibration dampers which reduces manufacturing cost. Also, the use of a high strength injection molded polymer material, a unique construction with an end cap to provide added structure and an internal mass construction manufacturing also contribute to the reduction of manufacturing costs. Internal mass designs have polyvee grooves molded into the hub, not machined into the inertia ring. The use of high strength polymer materials also eliminates the need for paint, lowering cost, and reduces parasitic inertia by reducing the weight of the hub. The use of polymer materials over metals also improves NVH characteristics (ringing) of the torsional vibration damper. The internal mass design of tortional vibration hub assembly 12 provides for an inherent “limp-home” failure mode where the car can still be driven home even if the inertia ring come off because the accessory belt rides on the hub, not the inertia ring.

While the invention has been described in terms of various specific embodiments, those skilled in the art will recognize that the invention can be practiced with modification within the spirit and scope of the claims.

What is claimed is:

1. A torsional vibration damper hub assembly for a motor vehicle engine, the engine comprising a crank shaft having a front end extending through the engine, said torsional vibration damper hub assembly comprising:
a hub member comprising a filled thermoplastic material and having an outer wall, said thermoplastic material comprising at least one filler;
an inertia ring positioned inside said hub member;
a rubber insert positioned between said inertia ring and said outer wall of said hub member; and
an end cap coupled to said hub member enclosing said inertia ring and said rubber insert inside said hub member.

2. A tortional vibration damper hub assembly in accordance with claim 1 further comprising a metal sleeve molded into said hub member, said sleeve insert molded with said filled thermoplastic material of said hub member.

3. A torsional vibration damper hub assembly in accordance with claim 1 wherein said end cap comprises said filled thermoplastic material.

4. A torsional vibration damper hub assembly in accordance with claim 1 wherein an outer surface of said outer wall of said hub member comprises a plurality of polyvee grooves.

5. A torsional vibration damper hub assembly in accordance with claim 1 wherein said thermoplastic material comprises at least one of a polyamid, a polyphenylene sulfide, a polyethyl imide, and a polyphthalamide.

6. A torsional vibration damper hub assembly in accordance with claim 1 wherein said at least one filler comprises at least one of metal fibers, metalized inorganic fibers, metalized synthetic fibers, glass fibers, graphite fibers, carbon fibers, ceramic fibers, mineral fibers, basalt fibers, inorganic fibers, aramid fibers, and mineral fillers.

7. A torsional vibration damper hub assembly in accordance with claim 3 wherein said end cap is coupled to said hub member by at least one of vibration welding, laser welding, adhesive bonding, and spin welding.

8. A torsional vibration damper hub assembly in accordance with claim 1 wherein said hub member further comprises a center portion and a back wall, said center portion coupled to said outer wall by said back wall.

9. A torsional vibration damper hub assembly in accordance with claim 8 wherein said center portion, said back wall, and said outer wall defining a cavity, said cavity sized to receive said inertia ring and said rubber insert.

10. A torsional vibration damper hub assembly in accordance with claim 8 further comprising a metal sleeve molded into said hub member, said metal sleeve located in said center portion of said hub member, said metal sleeve sized to receive the front end of the crank shaft enabling said tortional vibration damper hub to be attached to the engine.

11. An internal combustion engine comprising:
an engine block;
a crank shaft located in said engine block;
at least one accessory attached to said engine block;
an accessory drive belt coupled to each accessory; and
a torsional vibration damper hub assembly coupled to said crank shaft and to said accessory drive belt, said torsional vibration damper hub assembly comprising:
a hub member comprising a filled thermoplastic material and having an outer wall, said thermoplastic material comprising at least one filler;
an inertia ring positioned inside said hub member;
a rubber insert positioned between said inertia ring and said outer wall of said hub member; and
an end cap coupled to said hub enclosing said inertia ring and said rubber insert inside said hub member.

12. An engine in accordance with claim 11 wherein said torsional vibration damper hub assembly further comprises a metal sleeve molded into said hub, said sleeve insert molded with said filled thermoplastic material of said hub member.

13. An engine in accordance with claim 11 wherein said end cap comprises said filled thermoplastic material.

14. An engine in accordance with claim 11 wherein an outer surface of said outer wall of said hub member comprises a plurality of polyvee grooves.

15. An engine in accordance with claim 11 wherein said thermoplastic material comprises at least one of a polyamid, a polyphenylene sulfide, a polyethyl imide, and a polyphthalamide.

16. An engine in accordance with claim 11 wherein said at least one filler comprises at least one of metal fibers, metalized inorganic fibers, metalized synthetic fibers, glass fibers, graphite fibers, carbon fibers, ceramic fibers, mineral fibers, basalt fibers, inorganic fibers, aramid fibers, and mineral fillers.

17. An engine in accordance with claim 13 wherein said end cap is coupled to said hub member by at least one of vibration welding, laser welding, adhesive bonding, and spin welding.

18. An engine in accordance with claim 11 wherein said hub member further comprises a center portion and a back wall, said center portion coupled to said outer wall by said back wall.

19. An engine in accordance with claim 19 wherein said center portion, said back wall, and said outer wall defining a cavity, said cavity sized to receive said inertia ring and said rubber insert.

20. An engine in accordance with claim 17 further comprising a metal sleeve molded into said hub member, said metal sleeve located in said center portion of said hub member, said metal sleeve sized to receive a front end of said crank shaft to attach said tortional vibration damper hub to said engine.
